(19) United States
(12) Patent Application Publication
(10) Pub. No.: US 2006/0133407 A1
(43) Pub. Date: Jun. 22, 2006

(54) Content sharing in a communication system

(75) Inventor: Jussi Kuisma, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/063,842

(22) Filed: Feb. 23, 2005

(30) Foreign Application Priority Data
Dec. 21, 2004 (FI) FI 20041638

(51) Int. Cl. H04L 12/413

(52) U.S. Cl. 370/447; 370/401

(57) ABSTRACT

A method provides control of access to shared content in a communication system. The method comprises obtaining presence information with at least one access criterion associated with an access to shared content. The method further comprises receiving an access request requesting an access to at least one part of the shared content. The method further comprises verifying the access request against the at least one access criterion. The method further comprises processing the access request based on a result of the step of verifying. Furthermore, a controlling entity is configured to execute the method.

### FIELD OF THE INVENTION

The invention relates to communication systems, and more specifically to content sharing. In particular, the invention relates to monitoring access to shared content in a communication system.

### BACKGROUND OF THE INVENTION

A communication system can be seen as a facility that enables communication sessions between two or more entities such as one or more communication devices and/or other nodes associated with the communication system. A communication system typically operates in accordance with a given standard or specification setting out what the various entities associated with the communication system are permitted to do and how that should be achieved. A standard or specification may define a specific set of rules, such as communication protocols and/or parameters, on which connections between the entities can be based.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS). A single communication system may interface with one or more communication systems, such as with other wireless systems, such as a wireless local area network (WLAN) or a wireless Internet Protocol (IP) network, and/or fixed line communication systems.

Subscribers, such as the users or end-users, to a communication system may be offered and provided numerous services, such as calls, data communication or multimedia services or simply an access to a network, such as the Internet. Servers may be used in provision of the services and may be operated by an operator of a network or by an external service provider. For example, a mobile communication device may allow a user thereof to browse the Internet. For example, a wireless application protocol (WAP) provides mobile communication devices wireless services over the Internet from fixed information servers, such as Internet servers and Web servers. Further examples of services may comprises, but are not limited to, short message service (SMS), multimedia messaging service (MMS), electronic mail (email), and so on.

A user of a communication device may share content with other users. File sharing is an application for sharing pictures, video clips, audio clips and files with other user of the communication system. Said other users may visit, view and download content to be shared in so-called share folders or shared content of the user. The content to be shared may be stored either in a memory means of the communication device or in a server in a network. IP multimedia core networks may enable the file sharing in a mobile communication system environment.

A user, called herein a sharing user, can mark the content, such the files, stored in a communication device of the sharing user that the sharing user wants to share as shared content with other users. Once the content is marked as shared content, the other users can view and fetch the shared content from said communication device of the sharing user.

The sharing user may want to control and decide who can access the shared content. Another user may request an access to the shared content by sending a file sharing request to a session initiation protocol (SIP) address of the sharing user. The other user, who sent the file sharing request, may have access to the shared content, if the sharing user accepts the file sharing request. Typically, the sharing user accepts or denies each request individually and manually.

It might be desired to improve the control of the access to the shared content.

It shall be appreciated that these issues are not limited to any particular communication environment, but may occur in any appropriate communication system.

### SUMMARY OF THE INVENTION

In accordance with an aspect of the invention, there is provided a method for controlling access to shared content in a communication system. The method comprises obtaining presence information with at least one access criterion associated with an access to shared content. The method further comprises receiving an access request requesting an access to at least one part of the shared content. The method further comprises verifying the access request against the at least one access criterion. The method further comprises processing the access request based on a result of the step of verifying.

In an embodiment, a user sharing the shared content may be allowed to set the at least one access criterion for at least one part of the shared content.

In an embodiment, the access request may comprise a session initiation protocol message identifying the at least one part of the shared content and a requesting party. In an embodiment, it may be verified whether the at least one access criterion allows the requesting party to access the at least one part of the shared content.

In an embodiment, the at least one part of the shared content may be mapped with an address of an entity storing presence information for the at least one part of the shared content. The presence information may be enquired from said entity.

In another embodiment, the at least one part of the shared content may be mapped with presence information stored together with the at least one part of the shared content.

In an embodiment, the access may be allowed to the at least one part of the shared content when the step of verifying shows that the at least one access criterion allows the requesting party to access the at least one part of the shared content.

In an embodiment, the access may be denied to the at least one part of the shared content when the step of verifying shows that the at least one access criterion does not allow the requesting party to access the at least one part of the shared content.

In accordance with a further aspect of the invention, there is provided a computer program comprising program code means for performing any of the steps according to embodiments of the invention when the program is run on a computing means.

In accordance with a further aspect of the invention, there is provided a controlling entity for controlling access to shared content in a communication system. The controlling entity is configured to obtain presence information with at least one access criterion associated with an access to shared content. The controlling entity is further configured to receive an access request requesting an access to at least one part of the shared content. The controlling entity is further configured to verify the access request against the at least one access criterion. The controlling entity is further configured to process the access request based on a result of the step of verifying.

In an embodiment, the controlling entity may be an application server implemented in a communication device. In an embodiment, the controlling entity may be an application server implemented in a communication device in a network application server.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a message sequence chart illustrating an embodiment of the invention; and

FIG. 3 shows a flow chart illustrating an embodiment of the invention.

### DETAILED DESCRIPTION OF PREFERRED EMBODIMENTS

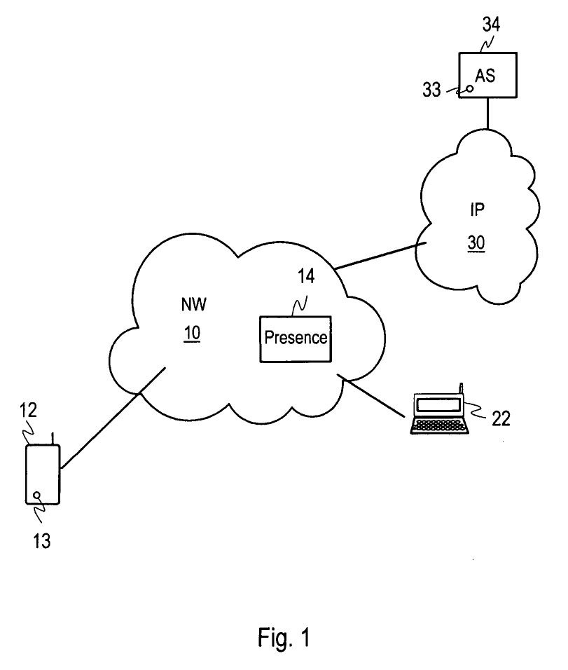

Reference is made to FIG. 1 showing an example of a network architecture in which embodiments of the invention may be implemented. In FIG. 1, a first communication device 12 and a second communication device 22 are arranged to access a communication network 10. A public data network, such as an IP network 30, is shown to interface with the communication network 10.

Furthermore, an application server (AS) 34 is shown. A communication device 12, 22 may connect to the application server that may be connected to one or more data networks such as, but not limited to, the exemplifying IP network 30. It shall be appreciated that a great number of application servers may be connected to each data network.

Furthermore, a presence server 14 is shown. Operation of the exemplifying presence server in embodiments of the invention shall become clear from the following description.

It shall be appreciated that FIG. 1 is only an example showing only two networks, two communication devices, one application server and one presence server. The number and type of entities concerned in a communication system may differ substantially from that which is shown. Communication networks typically further comprise various switching and other control entities and gateways for enabling the communication for interfacing a single communication network with one or more communication networks. In order to enhance clarity, these control entities are not shown in FIG. 1. A communication system is typically arranged to serve a plurality of communication devices. Furthermore, a communication device may have several simultaneous communication sessions, for example a number of session initiation protocol (SIP) sessions and activated packet data protocol (PDP) contexts. Communication devices may be connected to the communication system from the same or different networks. Communication devices may access the communication network 10 via any appropriate access system. Examples may include, but are not limited to, radio access networks, e.g. an UMTS terrestrial radio access network (UTRAN) or a GSM/EDGE radio access network (GERAN), and short-range wireless systems, such as the Bluetooth, different types of fixed access systems, and so on.

A mobile communication network may logically be divided into a radio access network (RAN) and a core network (CN). A communication device 12, 22 may access the communication network 10 via an access entity (not shown) of the RAN. The communication device 12, 22 may, for example, wirelessly transmit and receive radio signals via a radio interface to and from a transceiver network element connected to the access entity. Correspondingly, the transceiver network element may wirelessly transmit and receive radio signals to and from the communication device 12, 22.

Services over wireless communication networks may use capabilities of, for example, the Internet Protocol multimedia (IM) core network subsystem (IMS). The IMS enables IP connections for a communication device and other parties to the communication, such as other communication devices or entities associated with the network. The third generation partnership project (3GPP) has defined use of the GPRS for offering IP connectivity to IMS services. The 3GPP has further defined a call control protocol for use in the IMS based on a session initiation protocol (SIP) and an associated session description protocol (SDP).

In an embodiment, the communication network 10 is a SIP controlled network. Further, in an embodiment, the communication network 10 is provided at least in part by the IMS. In the IMS, SIP based connection control is handled by SIP proxies called Call State Control Functions (CSCFs, not shown in the figure). Another appropriate communication system may be used as well.

In a 3GPP network, a packet data session is established to carry traffic flows over the network. Such a packet data session is often referred to as a packet data protocol (PDP) context. A PDP context may include a radio bearer provided between a communication device and a radio network controller, a radio access bearer provided between the communication device, the radio network controller and a serving GPRS support node (SGSN), and switched packet data channels provided between the SGSN and a gateway GPRS support node (GGSN). Each PDP context usually provides a communication pathway between a particular communication device and the GGSN and, once established, can typically carry multiple flows. Each flow normally represents, for example, a particular service and/or a media component of a particular service. The PDP context therefore often represents a logical communication pathway for one or more flow across the network. To implement the PDP context between the communication device and the SGSN, radio access bearers (RAB) need to be established which commonly allow for data transfer for the communication device. The implementation of these logical and physical channels is known to those skilled in the art and is therefore not discussed further herein.

An end-user may access a communication network by means of any appropriate communication device, also called terminal. Examples may comprise user equipment (UE), a mobile station (MS), a cellular phone, a personal digital assistant (PDA) and a personal computer (PC). Further examples may comprise any other equipment operable according to a suitable network or transport protocol, such as a Session Initiation Protocol (SIP), a Real-Time Transmission Protocol (RTP), a File Delivery over Unidirectional Transport (FLUTE), a wireless applications protocol (WAP) or a hypertext transfer protocol (HTTP).

A communication device may be provided with an antenna or other such transceiver and receiver means for wirelessly receiving and transmitting signals from and to a transceiver network element of a wireless communication system. A communication device may also be provided with a display and a speaker. The operation of a communication device may be controlled by means of a suitable user interface comprising control means, such as a keypad, voice commands, touch sensitive screen or pad, or combinations thereof, or the like. The user interface may display a user a menu, a list or the like and allow the user to select an option from the menu. The user may indicate the selection by using the control means. The user interface may detect user activity and communicate the selection to a communicating logic of the communication device. A communication device is typically provided with a processor and memory means as well as software and applications operating the device and enabling operation with other entities. Software, which is able to request services from other entities in a communication system, may be called a client.

A communication system may support the session initiation protocol (SIP) as developed by the Internet engineering task force (IETF). The SIP is an application layer control protocol for creating, modifying and terminating sessions with one or more participants, i.e. end-points. A user connected to a SIP base communication system may communicate with various entities of the communication system based on standardized SIP messages. Communication devices or users who run certain applications on the communication devices are registered with the SIP backbone so that an invitation to a particular session can be correctly delivered to these end points. Uniform Resource Identifiers (URIs) may be used to identify different types of actors in a SIP-controlled network. Typically a URI points to a registered user identity of an individual user. A URI may identify also services or other types of resources. Other types of SIP addresses might also be used to identify different types of actors in the SIP-controlled network.

In embodiments of the invention, the communication device 12 may store content in a memory means of the communication device 12 or in an application server implemented in the communication device 12. A user of the communication device 12 may define at least a part of the content as shared content 13. The shared content 13 stored in the communication device may be made available to other users in an appropriate way.

In an embodiment, a user wanting to download shared content may start a file sharing application in his device. Within that the file sharing application the user may send a file-sharing request to a SIP address of a sharing user who has content to share. The network may resolve the SIP address and forward the request to a target terminal, or, in other words, to a communication device having the content to share. In the target terminal, a file sharing application may be started based on the file-sharing request, unless the file sharing application is already running. The file sharing application may receive the request and pop up a dialog to the sharing user, the dialog informing that another user is requesting to download shared content from the communication device of the sharing user. The sharing user may decide if the other user is allowed to download content or not. The other user may get a response to his file-sharing request.

After this initial negotiation, the file-sharing applications may use SIP messages to exchange actual files of the content to share.

As was explained above, in a known solution, a user of the communication device may control and decide who can access the shared content by manually accepting or denying a file sharing request sent by another user.

In further embodiments of the invention, with a file sharing application, a user wanting to share content can use also a network based storage for his shared files. The sharing user may use the file sharing application to upload the shared content to a network server, such as an application server 34. With the same file sharing application the user may set who can access said shared content.

It has now been found that controlling access to shared content might be improved by providing access lists in relation to presence functionality. A sharing user might create a number of list defining who is allowed to access and which part of the shared content, such as which files or folders. Other users may be allowed to subscribe status. For example, a status notification may be sent to status subscribing users when the sharing user adds a folder of file or otherwise updates the shared content.

Access rights may be set in the presence server 14 of FIG. 1. In this file sharing context each file or folder has a presence. This presence may be set and modified by the owner of the shared content, that is, the sharing user. When setting content to be shared, a presence entry is created, or registered, for each file in the presence server 14. The sharing user may set the presence of a shared file, for example who can see the file and who can access the file. Another user may then try to see and access the shared content 13, 33 in an application server, such as in the communication device 12 or in the network application server 34. The application server may check from the presence server 14 if an access is allowed for this particular other user.

Embodiments of the invention may render a process of accepting or denying access to be performed passively from the point of view of the sharing user once the sharing user has created the access lists. The process of accepting or denying access may be performed in a network element, thus outside the sharing communication device. The process of accepting or denying access would thus not consume processor time, battery, data connection and other such resources of the sharing communication device.

Presence functionality provides a network-based service for storing and distributing presence information of a user using a communication device to other users using other communication devices. Users may be allowed to subscribe to each other's presence information and be notified of changes in state. Presence is defined in document RFC2778, A Model for Presence and Instant Messaging.

Referring back to FIG. 1, presence functionality may comprise a first user of the first communication device 12 to send a registration request to the presence server 14. The registration request may contain presence information of the first user encoded in an appropriate format, such as in extensible markup language (XML) format. Further examples of mechanisms for delivering presence information to the presence server may comprise, but are not limited to, HTTP, simple object access protocol (SOAP), or the like. A second user using the second communication device 22 may subscribe to the presence information of the first user. For subscribing, the second user may send a message to the presence server 14. The second user may receive the presence information, if the first user authorizes. The presence information may be delivered to the second user using appropriate signaling, such as in a SIP NOTIFY message.

In an embodiment, a third user using the web browser 32 may subscribe to the presence information of the first user in addition to or instead of the second user.

The presence server 14 may be implemented in an appropriate network element. An example of an appropriate network element may comprise, but is not limited to, a serving controller, for example a serving call session control function (S-CSCF).

In embodiments of the invention, a base format for presence described in document RFC3863, Presence Information Data Format (PIDF), August 2004, by the Internet Engineering Task Force (IETF), may be used. The PIDF is a common presence data format for presence protocols compliant with common profile for presence (CPP), which is defined in document RFC 3859, Common Profile for Presence (CPP), August 2004, by the IETF.

According to RFC3863, the base format of presence may comprise presence information providing at least means for uniquely identify the user who is presenting the presence information, status information and, optionally, communication address and/or other presence information. The means for uniquely identify the user who is presenting the presence information may comprise a uniform resource locator (URL) or the like. The status indicates at least acceptance of instant message and optionally of other communication means. A user setting the presence information may indicate preferences over a multiple contact means. For example, a user may accept instant messages, email and call. The user may indicate a preference, for example, for instant messages.

Furthermore, the presence information may be time-stamped. A time-stamp may let a receiver of the presence information know the time of creation of the presence data even if a message containing the presence information is delayed. The presence information may further comprise an optional human readable comment.

The presence information may be encoded in an XML format document. The presence information extensible framework is based on XML namespaces. AI elements and some attributes are associates with a namespace, which in turn is associated with a globally unique URI. Presence information elements of a particular user may be uniquely identified by using an appropriate namespace and by associating the presence elements with the namespace by a namespace prefix. PIDF based documents can be easily extended to handle this file sharing concept as “original” PIDF handles a person related presence information.

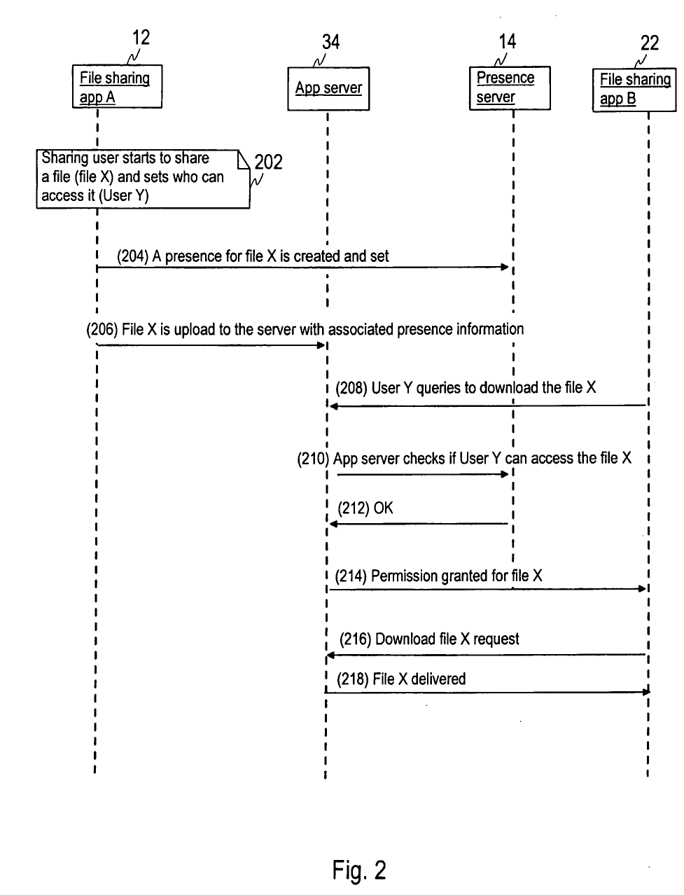

FIG. 2 shows a message sequence chart for setting a file to be shared and how it is accessed from the application server implemented in the communication device 12 or the network application server 34. A sharing user is using the communication device 12 and may set shared content in an application server, which may be one of the application serves implemented in the communication device 12 and the network application server 34, or in both of them. When another user wanting to download content contacts the SIP address of the communication device of the sharing user directly, the content of communication device 12 may be used and otherwise content in the network application server 34 may be used. In an embodiment, the application server may hold a list indicating from where the content may be downloaded. The list might include an own address of the application server holding the list or an address of some other application server. In the example of FIG. 2, for clarity, only the network application server 34 is used as an exemplifying application server.

In step 202, sharing user starts to share a file (file X) using a file sharing application A of the communication device 12. The sharing user sets at least one access criterion, such as who can access the file X. In this example, the sharing user sets that user Y can access the file X. In step 204, a presence is created for file X and set in the presence server 14. In step 206, the file X is upload to the application server 34 together with associated presence information. In step 208, the user Y, using a file sharing application B implemented in the communication device 22, queries from the application server 34 to download the file X. In step 210, the application server 34 checks from the presence server 14 if the user Y is allowed to access the file X. In step 212, the presence server 14 may send an approval, if the presence server 14 determines that the user Y is allowed to access the file X. In step 214, the application server 34 may inform the user Y that permission is granted for file X. In step 216, the user Y may send a request to download file X. In step 218, file X may be delivered.

In an embodiment, in step 210, the presence server 14 may determine that the user Y is not allowed to access the file X. In such a situation, the application server 34 may inform the user Y, in step 214, that permission is not granted for file X. File X may thus not be delivered.

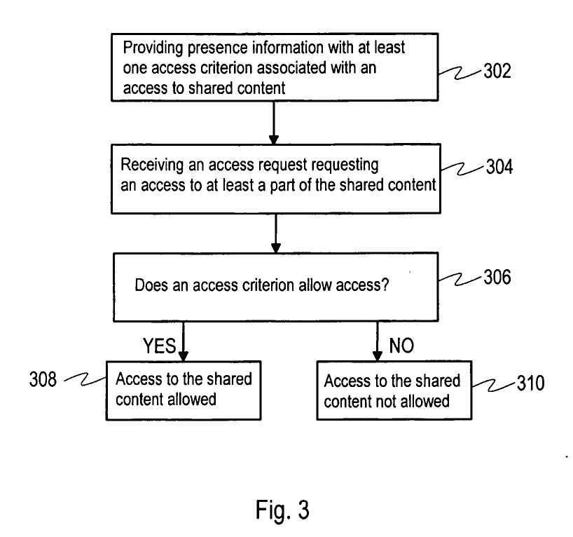

FIG. 3 shows a flow cart illustrating an embodiment of the invention. In step 302, presence information stored in a presence server is provided with at least one access criterion associated with an access to shared content. The at least one access criterion may be set by a first user sharing said content. In an alternative, the at least one access criterion may be set by an operator or a third party controlling the presence server.

In step 304, an access request requesting an access to the shared content is received. The access request may be received from a second user as was explained above. The access request may comprise a SIP message, which is received by the application server. The SIP message may identify at least a part of the shared content, such as a file, to be accessed and a requesting party, such as a user or a communication device sending the message. In an embodiment, the shared content may be identified in whole in the request.

In step 306, the access request is verified against the at least one access criterion. In an embodiment, verifying may comprise verifying an identifier of a communication device of the second user requesting the access. The application server may check if the user associated with the identifier is allowed to access the file or not. The application server may have, for example, a table mapping together the file and from where correct information can be found. The application server may find an address of the presence server from said correct information and check what is the presence information for that particular file. In an alternative, the application server can cache presence information associated with the files the application server is holding. The application server can refresh or update the information at intervals from the presence server.

The access request is processed based on a result of the step of verifying. In step 308, progress of the access request is allowed when the step of verifying shows that the at least one access criterion allows the access. If the presence set to the file entitles the user sending the request to access the file, access is granted to the user. For example, if the identifier of the communication device of the second user requesting the access is included in the at least access criterion and marked as allowed, the progress of the access request may be allowed. In step 310, progress of the access request is denied when the step of verifying shows that the at least one access criterion does not allow the access.

Although the invention has been described in the context of particular embodiments, various modifications are possible without departing from the scope and spirit of the invention as defined by the appended claims. In particular, even if a mobile telephone is mainly used as an exemplifying device providing the server, embodiments of the invention may be implemented using other appropriate communication devices. Furthermore, even if a mobile communication system is used as an exemplifying communication system, other appropriate communication systems may also be used.

1. A method for controlling access to shared content in a communication system, the method comprising:
obtaining presence information with at least one access criterion associated with an access to shared content;
receiving an access request requesting an access to at least one part of the shared content;
verifying the access request against the at least one access criterion; and
processing the access request based on a result of the step of verifying.

2. The method according to claim 1, wherein the step of obtaining comprises allowing a user sharing the shared content to set the at least one access criterion for the at least one part of the shared content.

3. The method according to claim 1, wherein the step of receiving comprises receiving a session initiation protocol message identifying the at least one part of the shared content and a requesting party.

4. The method according to claim 3, wherein the step of verifying comprises verifying whether the at least one access criterion allows the requesting party to access the at least one part of the shared content.

5. The method according to claim 4, wherein the step of verifying comprises mapping the at least one part of the shared content with an address of an entity storing the presence information for the at least one part of the shared content.

6. The method according to claim 5, wherein the step of verifying further comprises enquiring the presence information from said entity.

7. The method according to claim 4, wherein the step of verifying comprises mapping the at least one part of the shared content with the presence information stored together with the at least one part of the shared content.

8. The method according to any of claims 3, wherein the step of processing comprises allowing the access to the at least one part of the shared content when the step of verifying shows that the at least one access criterion allows the requesting party to access the at least one part of the shared content.

9. The method according to any of claims 3, wherein the step of processing comprises denying the access to the at least one part of the shared content when the step of verifying shows that the at least one access criterion does not allow the requesting party to access the at least one part of the shared content.

10. A computer program embodied on a computer readable medium, said computer program controlling a computing system to perform the steps of:
obtaining presence information with at least one access criterion associated with an access to shared content;
receiving an access request requesting an access to at least one part of the shared content;
verifying the access request against the at least one access criterion; and
processing the access request based on a result of the step of verifying.

11. A controlling entity for controlling access to shared content in a communication system, the controlling entity configured to:
obtain presence information with at least one access criterion associated with an access to shared content;
receive an access request requesting an access to at least one part of the shared content;
verify the access request against the at least one access criterion; and
process the access request based on a result of the verification.

12. A controlling entity for controlling access to shared content in a communication system, the controlling entity comprising:
obtaining means for obtaining presence information with at least one access criterion associated with an access to shared content;
receiving means for receiving an access request requesting an access to at least one part of the shared content;
verifying means for verifying the access request against the at least one access criterion; and
processing means for processing the access request based on a result of the step of verifying.

13. The controlling entity according to claim 11, comprising an application server implemented in a communication device.

14. The controlling entity according to claim 11, comprising an application server implemented in a communication device in a network application server.

15. The controlling entity according to claim 12, comprising an application server implemented in a communication device.

16. The controlling entity according to claim 12, comprising an application server implemented in a communication device in a network application server.
